(19) United States
(12) Patent Application Publication
(10) Pub. No.: US 2023/0358911 A1
(43) Pub. Date: Nov. 9, 2023

(54) USING AN ACOUSTIC TOOL TO IDENTIFY EXTERNAL DEVICES MOUNTED TO A TUBULAR

(71) Applicant: DarkVision Technologies Inc, North Vancouver (CA)

(72) Inventors: Timothy Luu, North Vancouver (CA); Anas Mahmoud, Toronto (CA)

(21) Appl. No.: 18/133,553

(22) Filed: Apr. 12, 2023

Related U.S. Application Data
(63) Continuation-in-part of application No. 17/091,271, filed on Nov. 6, 2020, now Pat. No. 11,733,380.

(30) Foreign Application Priority Data
Nov. 8, 2019 (GB) GB1916315.3

(51) Int. Cl. G01V 1/50

(52) U.S. Cl. CPC G01V 1/50

(57) ABSTRACT

A method, imaging tool and computer system for locating external devices mounted to a tubular in a wellbore. The identification of devices, such as cable clamps, enables other tools in the string to operate more precisely. A computer model is used to locate the devices from acoustic images, which images are acquired using a downhole imaging tool having an acoustic sensor or acoustic array. The model may be a classifier, which may be machine trained to classify whether a device is present, its location and its orientation. Automating this locating enables very long wellbores to be processed quickly.

### CROSS-REFERENCE TO RELATED APPLICATIONS

The present application is a Continuation in Part of U.S. patent application Ser. No. 17/091,271 filed on Nov. 6, 2020, which claims priority to United Kingdom patent application GB1916315.3, filed on Nov. 8, 2019.

### FIELD OF THE INVENTION

The invention relates generally to inspection of fluid-carrying systems, in particular, acoustic sensors detecting devices mounted to tubulars in oil and gas wells and pipelines.

### BACKGROUND OF THE INVENTION

In some industrial situations, devices are connected to the outside of the tubular to perform some function, often to monitor the fluid flowing or control operation. The performance of the devices or of other operations may be affected by the location or orientation of this devices. For example, cables for thermocouples, fiber, piezometers, and other instrumentation may be externally mounted using cable protectors clamped to the tubular. Their operation or the ability to perforate production casing may require knowing the devices' location (depth and azimuth), so that the clamp or cable running therebetween isn't severed during perforation. Other common external devices at risk include small stainless-steel tubes, float collars, landing collars, centralizers, connections, float subs, carriers, SSSV, sleeves and burst ports.

Existing tools use magnetic sensors to detect the extra metal mass of the devices. However, the azimuthal precision of these tools is quite low, so the location and orientation are uncertain. As a consequence, subsequent operations, such as perforating, are limited in angles where they can be performed.

WO2018183084A1 entitled “Cable system for downhole use and method of perforating a wellbore tubular” discloses a system to detect fibre optic cable by sensing magnetic permeability. The output is a value that is read by an operator to manually locate the cables.

The inventors have appreciated a need to locate the device with high precision and use this information in other downhole operations.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include deploying an imaging tool having an acoustic sensor into the tubular. Method may also include creating acoustic images using the acoustic sensor from acoustic reflections from the tubular and portions of the device contacting the tubular; processing the acoustic images with a first computer model to locate an inner surface of the tubular; selecting data of the acoustic images that are beyond the located inner surface; processing the selected areas with a second computer model to determine locations of the devices; and outputting the location of the devices. Other embodiments of this aspect include corresponding computer systems, apparatus, and computer programs recorded on one or more computer storage devices, each configured to perform the actions of the methods.

In one general aspect, computer system may include one or more non-transitory memories storing first and second computer models for processing acoustic images. Computer system may also include a processor configured to execute instructions stored in the one or more non-transitory memories to: a) receive acoustic images of tubulars and devices mounted externally thereto; b) process the acoustic images with the first computer model to locate an inner surface of the tubular; c) select data of the acoustic images that are beyond the located inner surface; d) process the selected areas with the second computer model to determine locations of the devices; and e) store the location of the devices in the one or more non-transitory memories. Other embodiments of this aspect include corresponding computer systems, apparatus, and computer programs recorded on one or more computer storage devices, each configured to perform the actions of the methods.

Thus, it is possible, not only to detect devices that are not normally visible within the tubular, but also to automate its identification and location determination. Further operations on the tubular may then be performed using the known locations of these externally mounted devices.

### BRIEF DESCRIPTION OF THE DRAWINGS

Various objects, features and advantages of the invention will be apparent from the following description of embodiments of the invention and illustrated in the accompanying drawings. The drawings are not necessarily to scale, emphasis instead being placed upon illustrating the principles of various embodiments of the invention.

FIG. 1 is a cross-sectional view of an imaging tool deployed in a wellbore in accordance with one embodiment of the invention.

FIG. 2 is a cross-sectional view of a tool with radial transducer array in a casing.

FIG. 3 is a side view of a cable protector in a closed position.

FIG. 4 is a cross-sectional view of the tool inspecting a casing and device mounted thereto.

FIG. 5 is a plot of acoustic reflections along a length of a casing vs azimuthal lines (left) beside the corresponding cable protector model (right).

FIG. 6 is an end view of a cable protector cemented in place on a casing.

FIG. 7 is a workflow for identifying devices from edge reflections.

FIG. 8 is an illustration of regions of a casing selected for processing.

FIG. 9A is an ultrasound image region containing an external device.

FIG. 9B is an ultrasound image region containing an external device.

FIG. 9C is an ultrasound image region containing an external device.

FIG. 10 is an ultrasound image with wrap-around padding.

FIG. 11A is a diagram of a first portion of an architecture for a Convolutional Neural Net for device detection.

FIG. 11B is a diagram of a second portion of the architecture in FIG. 11A.

FIG. 11C is a diagram of a third portion of the architecture in FIG. 11A.

FIG. 12 is a diagram of a regression network for device detection.

FIG. 13 is a block diagram of an encoder-decoder model's architecture.

FIG. 14 is a is a workflow for building and using a neural net model for surface detection.

FIG. 15A is an unwrapped acoustic image for surface segmentation training.

FIG. 15B is an illustration of boundary outputs from surface segmentation processing.

FIG. 16A is an unwrapped ultrasonic image overlaid with detected boundary.

FIG. 16B is a wrapped ultrasonic image overlaid with detected boundary.

FIG. 17 is an ultrasound image of maximum intensity values after clipping out inner reflections.

### DETAILED DESCRIPTION OF THE PREFERRED EMBODIMENTS

With reference to the figures, tools and methods are disclosed for scanning, identifying, and locating devices externally connected to a tubular, which generally have a long narrow form factor, through which the tool can move longitudinally. Tubulars may be oil/water pipelines, casing, and tubing. These tubulars often have devices, particularly instrumentation, mounted externally thereto. Cement may be used to fix the location of the external device and affects the acoustic coupling from the sensor to parts of the device. Cement or gas trapped by the cement tends to attenuate acoustic energy reaching parts of the device not in contact with the tubular, making the edges in contact detectable by the present device.

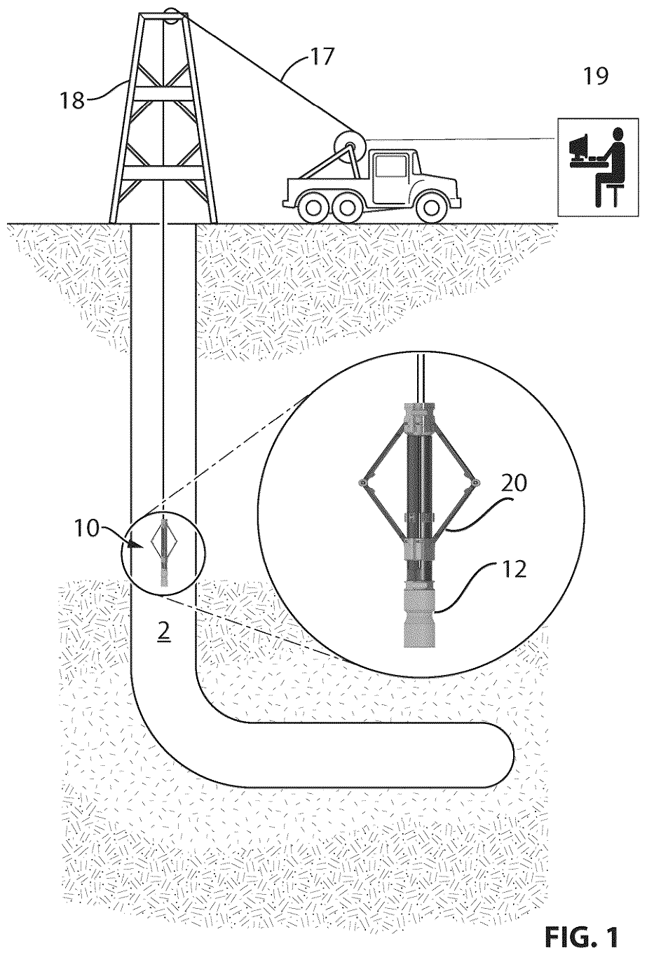

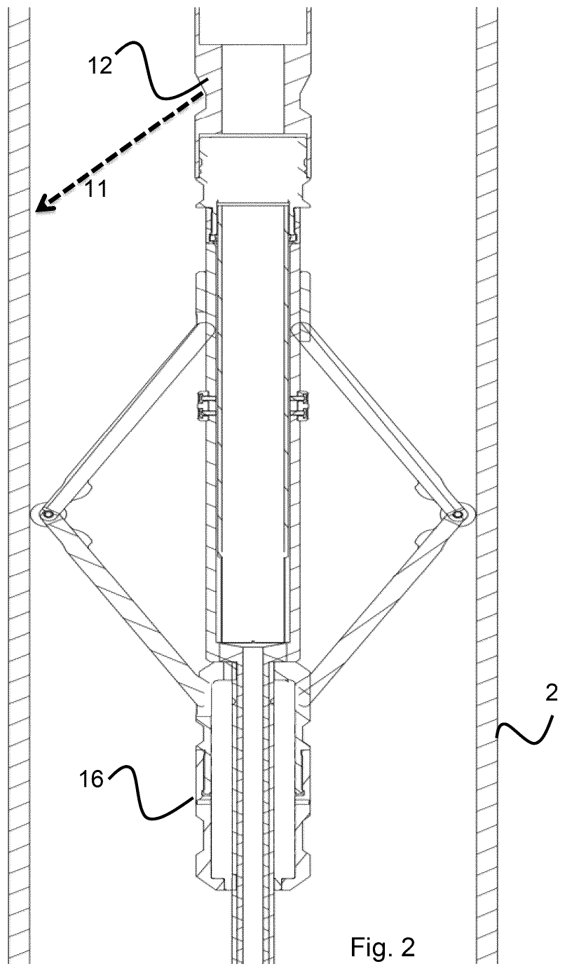

In accordance with one embodiment of the invention, there is provided an imaging tool 10 for imaging a wellbore 2, as illustrated in FIGS. 1 and 2. The imaging tool 10 comprises an acoustic transducer array 12, a body 16, a processing circuit, and memory for storing ultrasound images. The images may be transmitted to a computer 19 located external to the wellbore for processing and for controlling certain downhole operations. Acoustic transducers are desirable in fluid well inspection applications because they can work even in opaque fluids, can be beam steered to change the apparent direction of a wave-front, and can be beam focused to inspect different radii of the tubular, such as behind the outer wall of the tubular. Thus, the imaging tool can acquire 3D images of objects at depths behind other objects, in contrast to cameras which capture 2D images of only foreground objects.

The present system is automated using a computer model of devices to identify devices in a logged well from ultrasound images. The model may be a template matching algorithm, a geometric or CAD model, or a Machine Learning model. Advantageously, the present system may identify devices from ultrasound features that are undetectable to the human eye or visually meaningless. Such ultrasound features include glints, ringing, frequency changes, refraction, depth information, surfaces mating and materials affecting the speed of sound.

The imaging tool may comprise spinning head, radial array, or pitch-catch type transducers. The tool may be similar to that described in patent applications WO2016/201583A1 published 22 Dec. 2016 to Darkvision Technologies Ltd. Described therein is a tool having a linear array of radially-arranged outward-facing acoustic transducers. This conical design may also face uphole, i.e. towards the proximal end of the tool and the surface. The array 12 may be located at an end of the tool or between the ends. Alternatively, the tool may be similar to that described in GB2572834 published 16 Oct. 2019, whereby a longitudinally-distributed array is rotatable and movable within the wellbore.

### Transducers

The array comprises a plurality of acoustic transducer elements, preferably operating in the ultrasound band, preferably arranged as a one-dimensional array. The frequency of the ultrasound waves generated by the transducer(s) is generally in the range of 200 kHz to 30 MHz, and may be dependent upon several factors, including the fluid types and velocities in the tubular and the speed at which the imaging tool is moving. In most uses, the wave frequency is 1 to 10 MHz, which provides reflection from micron features. Conversely, low-frequency waves are useful in seismic surveying of the rock formation at deeper depths.

The number of individual elements in the transducer array affects the resolution of the generated images. Typically, each transducer array is made up of 32 to 2048 elements and preferably 128 to 1024 elements. The use of a relatively large number of elements generates a fine resolution image of the well. The transducers may be piezoelectric, such as the ceramic material, PZT (lead zirconate titanate). Such transducers and their operation are well known and commonly available. Circuits to drive and capture these arrays are also commonly available.

### Radially Configured Sensors

The transducers may be distributed equidistant around an annular collar of the imaging tool. As seen in FIG. 2, the array 12 may be substantially outward, radially-facing. The transducer array 12 may be distributed on a frusto-conical substrate with transducers facing partially in the longitudinal direction of the tool (and thus in the longitudinal direction when in the well). Thus, the radial transducers are angled uphole or downhole to form an oblique-shaped conical field of view. The cone may have a cone angle β of 10-45°, preferably about 20°. In this arrangement, much of the sound wave reflects further downward, but a small portion backscatters off imperfection on the surfaces, voids within the tubular or external device back towards the transducer.

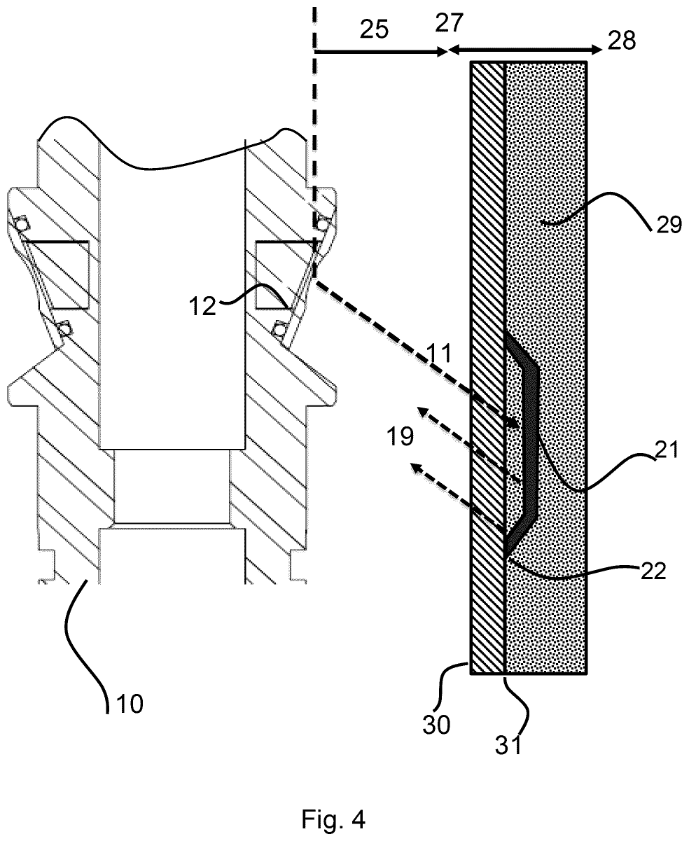

As illustrated in FIG. 4, a scan line 11 is emitted towards the well. A first reflection is received from the inner wall 30 and then a second reflection is received from the outer wall 31. However, there may be multiple reflections as the wave bounces between walls. Additional reflections 19 come from the device 21, particularly at the boundary with the tubular wall 31. The conical transducer arrangement captures a conical slice of the well at multiple azimuths. At each azimuth, the data comprises depth data based on the time that reflections arrive. The scan line data may be reduced to a single brightness value by integrating all the energy (B-mode filtering).

As the tool is moved axially in the well, in either a downhole or uphole direction, the transducer continually captures slices of the well and logs a 2D image of the well in the Z-Θ plane.

Compared to the present tool, purely radial arrays used for caliper or thickness measurement do not detect external device as well because the device reflections are weak and not significantly different from the expected thickness of the tubular alone.

### Scan Frame

An acoustic transducer element can both transmit and receive sound waves. A wave can be synthesized at a location on the sensor array 12, referred to as a scan line 11, by a single transducer element or a set of transducers, called the aperture. The number of scan lines N that make up a full frame may be the same as the number of elements M in the array, but they are not necessarily the same.

Multiple discreet pulses in the aperture interfere constructively and destructively. As known in the art, altering the timing of the pulse at each transducer can steer and focus the wavefront of a scan line in selectable directions. In steering, the combined wavefront appears to move away in a direction that is not-orthogonal from the transducer face, but still in the plane of the array. In focusing, the waves all converge at a chosen distance from a location within the aperture. Preferably, this focal point corresponds to the boundary of the tubular 31 and contacting points 22 of the device 21.

The tool comprises a processing circuit for generating and receiving signals from the transducers. The skilled person will appreciate that the circuit may implement logic in various combinations of software, firmware, and hardware that store instructions, process data and carry out the instructions.

The steps of the method are performed by a computer processor and may be described as automated, except where noted as performed by an operator to set up the tool and method. The computer processor accesses instructions stored in non-transitory memory. Some instructions are stored in the remote computer's memory with the remote computer's processor. Some instructions are stored in the tool's memory with the tool's processor to control the operation of the tool, its actuators, and high-level scanning steps, while the actual timing of transducers may be left to an FPGA.

### Operation

The present imaging tool may be operated by an operator using manual controls such as joysticks or using a Graphic User Interface via a computing tool. Control signals are sent from the operator's input down the wireline to the tool's control board.

The imaging tool includes a connection to a deployment system for running the imaging tool 10 into the well 2 and removing the tool from the well. Generally, the deployment system is wireline 17 or coiled tubing that may be specifically adapted for these operations. Other deployment systems can also be used, including downhole tractors and service rigs.

The tool moves through the tubular while capturing radial frames at a plurality of azimuthal scan lines. The transducers sonify the tubular at an angle of incidence of 20-60° measured axially from the surface normal. While a majority of the acoustic energy continues downhole or uphole, away from the transducer, a small amount backscatters off surface features/surface interfaces, and a large amount reflects from edges that protrude sharply from the tubular surface.

In particular, edges of the device that run circumferentially around the tubular (as opposed to axially) form a steep angle with the axially inclined scan line and thus reflect the wave bigly. Conversely, scan lines may only tangentially intersect the plane of axially running edges and thus reflect very little energy.

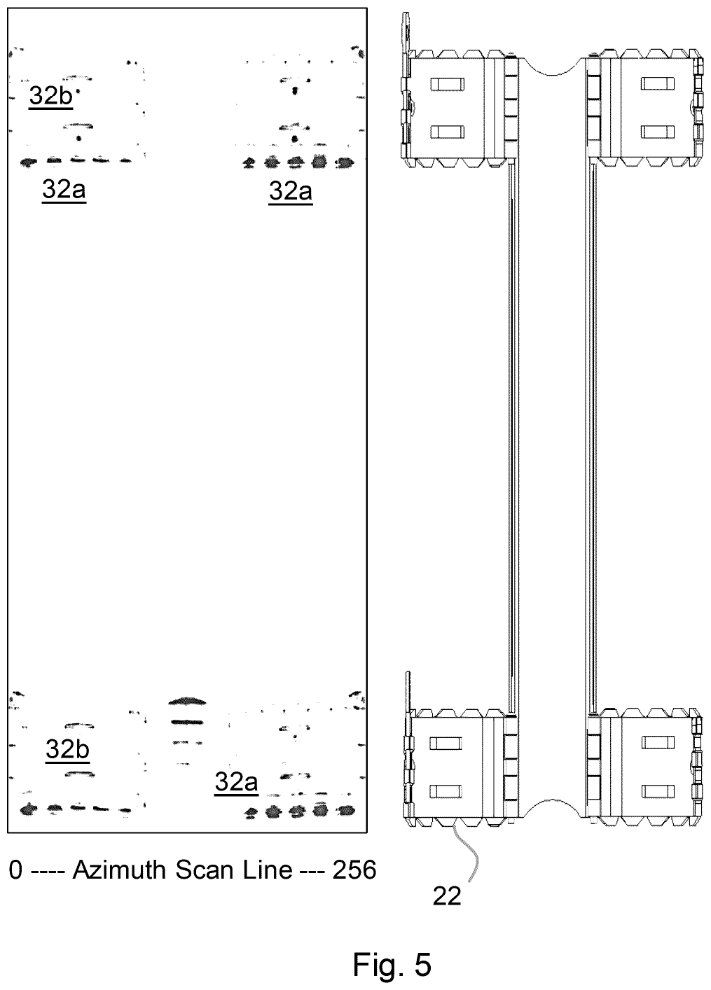

FIG. 5 is a brightness plot unwrapped for all azimuthal scan lines and corresponds to the cable protector to the right of the same scale. As can be seen, the ten “teeth 22 of the clamp correspond to the brightest features 32a and the mid-clamp indents correspond to weaker features 32b. In both of these cases, there may also be weak reflections from clamp teeth and indent edges that are parallel to the scan line.

### Device Edge Detection

The transducers receive acoustic reflections from the tubular's inner surface, outer tubular surface, tubular defects, tubular-device interface, outer device surface, and device edges. To identify the external device and its orientation most precisely, it is desirable to concentrate on external device edges and filter out the other reflections.

The processor may process the reflection data by summing the total reflected energy at each scan line and then determining the scan line where the energy exceeds the average. This averages out the tubular reflections which return generally similar energy. Voids, corrosion, and other damage in the tubular will also create excess reflections, but these form a random pattern that does not correspond to any known external devices.

The processor may filter out inner surface reflections by removing the initial reflection, which is typically the strongest signal and occurring at Tᵢₙₙₑᵣ (i.e. the time of flight for waves from the transducer to the inner wall of the tubular and back).

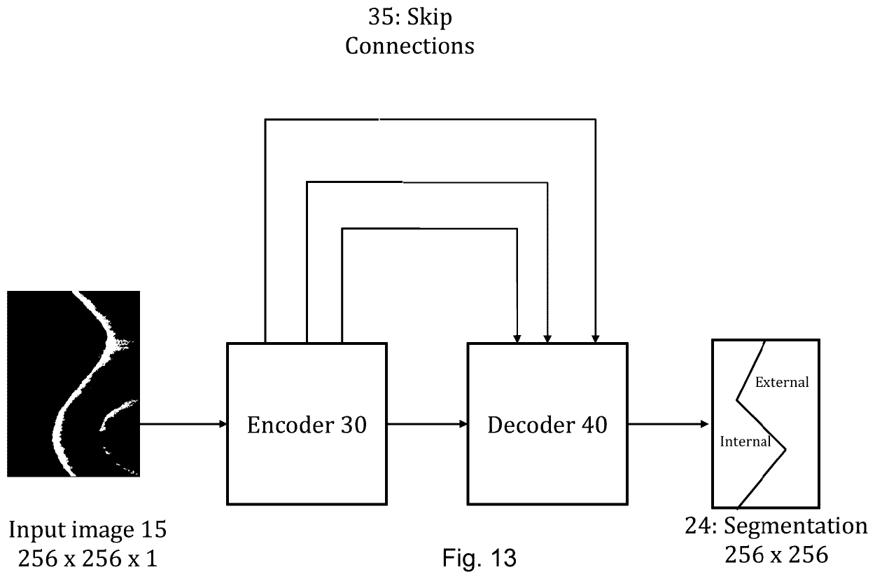

Alternatively, reflections from the tubular may be filtered out by ignoring signals arriving before a threshold time Tₒᵤₜₑᵣ, where Tₒᵤₜₑᵣ is the time of flight for waves from the transducer to the outer wall of the tubular and back. This threshold may be set by the operator based on expected fluid properties and tubular diameter or may be automatically set by the processor using the machine learning model of FIG. 13. The remaining signals correspond to the edges and outer surface of the device.

The filtered data from pixels at azimuthal and axial locations Θ, Z (the radial component may be ignored as the device is deemed to be located at the outer radius of the tubular) to create a very long 2D ultrasound image. The image may then be processed to find candidate edges using known edge detection algorithms. Common edge detection algorithms include Sobel, Canny, Prewitt, Roberts, and fuzzy logic methods. The output is a set of locations and vectors of edges, optionally with brightness values.

The edge detection algorithm may be tuned for edges found in the set of downhole devices to be identified. For example, only edge candidates of certain length, curvature, aspect ratio and brightness are considered for further processing. This may filter out tiny defects, large features that run the whole tubular, or 2D patches that correspond to surface textures.

Indeed, edge detection algorithms may also be used to filter the raw reflection data because surface features are usually not contiguous enough to form an edge and surface interfaces are generally planar and not edges.

In FIG. 5, the brightness values are taken from reflections after the tubular's outer surface to filter out tubular features. There are also point reflections from other surface artefacts that are not treated as edges because they are too small and do not connect to form a coherent edge.

### Cement Bond Detection

The external device is typically enveloped in the cement used to surround the casing and hold the casing to the open borehole. The bond quality of the cement and the presence of mud instead of cement between the device and casing is of concern to operators. The present method may be used to output a metric for the bond or determine the presence of mud/cement based on the reflections returned from within the boundaries of the device edges. So, although the method initially looks for bright reflections to determine device edges, additional reflection signals within the edges are useful too.

Cement is highly attenuative, so its presence between the device and the casing via a quality bond will not return much acoustic energy. Conversely a poor bond leads to a discontinuity between the cement/casing or cement/device surface which creates reflections over that patch of discontinuity. Thus, the lack of cement may be an indication of the presence of the clamp. The shape and size of the missing cement reflections should be related to that of the clamp and detectable by the computer model.

Conversely, mud between the device and casing will efficiently carry the acoustic signal then reflect off the surface of the device. These reflections arrive after the inner and outer casing reflections.

### Identification

The processor operates on the ultrasound image using a computer model of devices to locate and determine azimuthal orientation automatedly. The model may employ template matching, classification and/or regression.

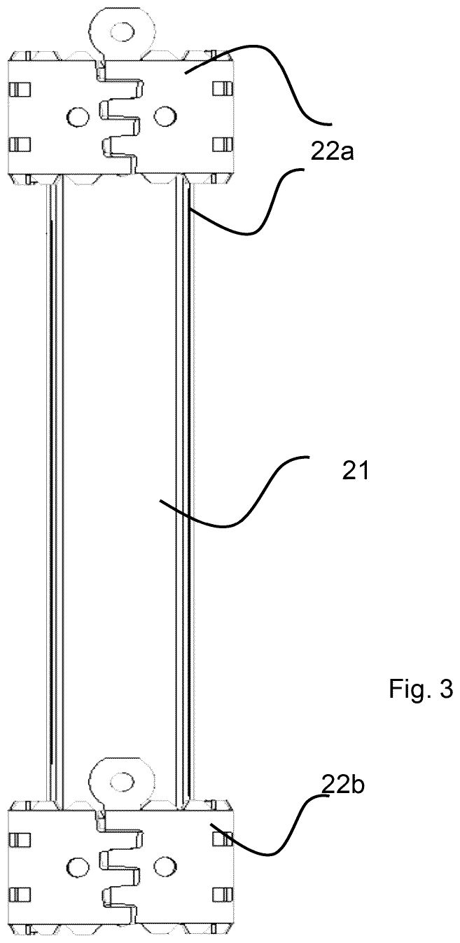

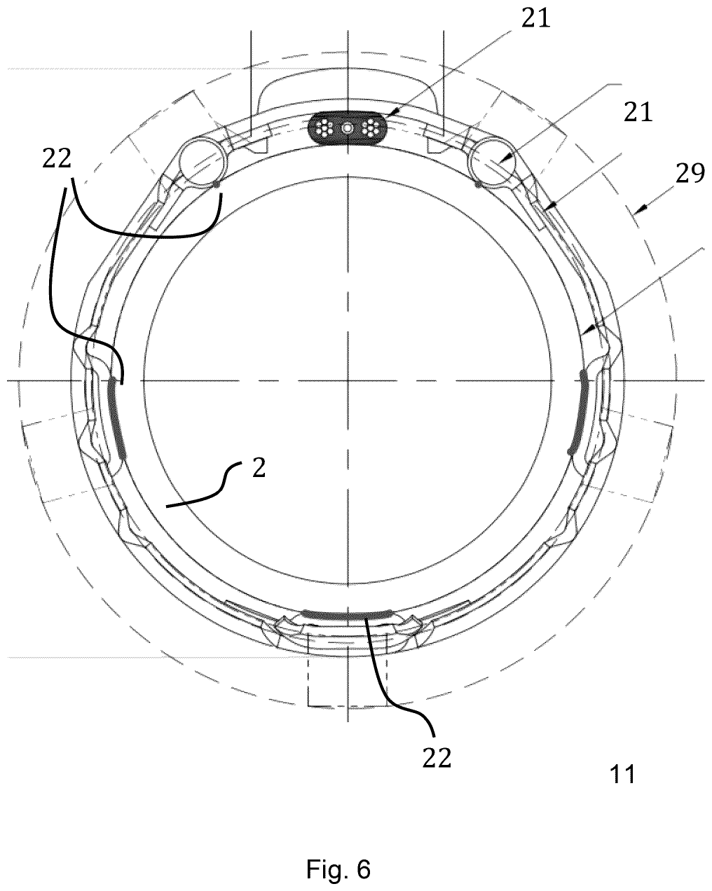

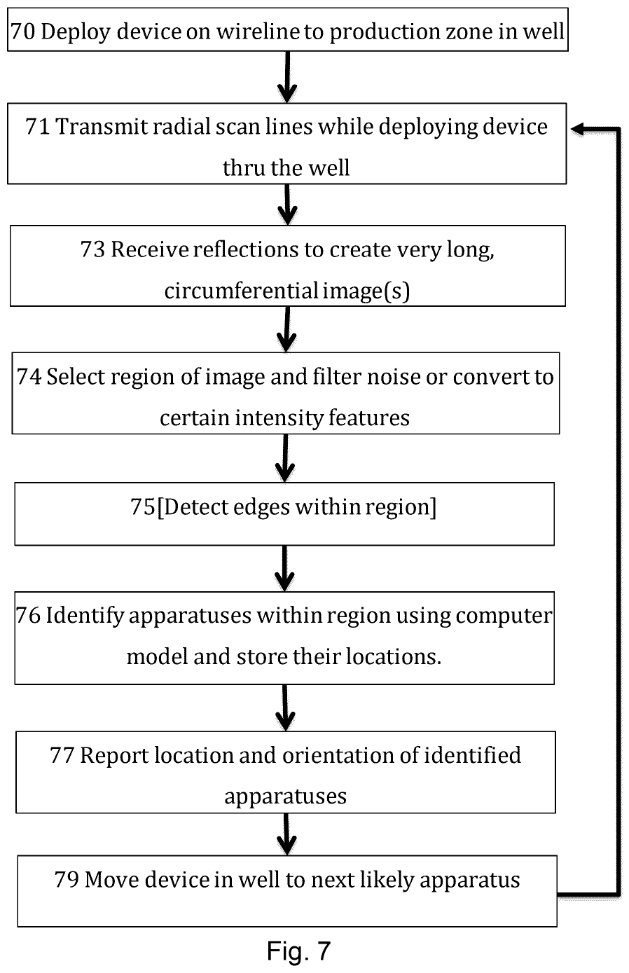

In one embodiment the identification, location, and orientation of the device may be determined from a set of at least two clustered edges to exceed a threshold probability. It has been found that at least two proximate edges are useful to identify a device's feature and at least two device features are useful to identify the device. An edge is determined by a set of largely contiguous pixels above a threshold signal and a device's feature. The processor further checks that the device's features are within a threshold distance of each other, based on the size of the device (e.g. if the largest device in the library is 2 m long then only features within two meters of each other are co-considered). For example, the cable protector 21 of FIG. 3 may be defined by four features: two upper strap arms and two lower strap arms. A single strap arm feature may be defined by edges from contact teeth 22a and indents 22b (see also bold contact lines 22 in FIG. 6).

The output may include a calculated probability that the correct device is identified, its location in the well and its orientation with respect to the tubular. The processing requirements may be reduced if the type of device in the well is already known, whereby the output simply confirms that the expected device corresponds to the detected edges.

The processor may combine several identified devices in the well to determine a twist in tubulars, device clamping condition, and cable trajectories. These may be added to a WellCAD model.

In certain embodiments, the processor applies a device identification machine learning (DML) model to the ultrasound image. Because a well is typically several thousand meters long, the DML model is applied to smaller selected image regions. The DML model returns whether that image region contains a device or not, or the most probable location of a device within the image region.

Without loss of generality the ultrasound image may be 3-dimensional, in which case the exemplary neural nets provided herein below have an extra dimension to convolve. However, to reduce processing time, the ultrasound image may be a 2D image with depth (z) and azimuthal (Θ) locations, as discussed above.

The ultrasound image may be convolved with a Neural Net to output a probability that an external device exists and where it is located within the well (depth Z and orientation θ). The inventors have found that a Convolutional Neural Net (CNN) is desirable because they are largely spatially invariant and computationally efficient, especially when run on a GPU or TPU (tensor processing unit). CNN architectures of the types used in RGB image processing to identify common objects may be used with some modifications to work on ultrasound “pixels” in circular images to identify devices. Modifications to their training are also provided below.

As a tubular is typically hundreds of meters to kilometers long, there are typically hundreds of clamps to detect. The system may thus maintain a database of detected devices, their identity (assuming various types exist on this tubular), their global location (z and Θ), and confidence(s) of the computer model's output(s). Further processing may de-duplicate entries for devices that overlap or are within a set distance of each other.

### Tubular Region Selection

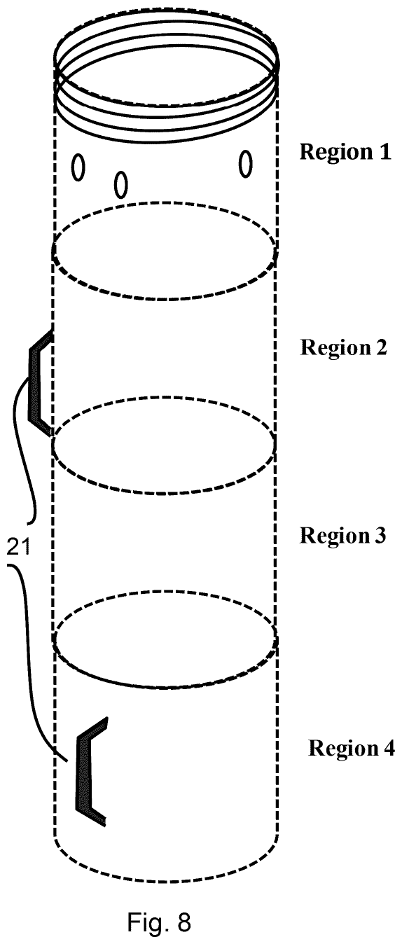

Tubular region selection may be the result of limiting acoustic scanning to a region of interest based on a prior information about the likely location of devices in the well. The region of interest may be known from the well plan layout or from a previously detected device in a chain of devices (e.g. fiber clamps connected 3 m apart in a production tubular 2000 m downhole). This approach might select Regions 2 and 4 in FIG. 8.

Alternatively, regions from a larger well image may be automatically proposed for device detection. A simple filter may be used to scan the well image quickly with a lower threshold for object detection. For example, in a long tubular largely devoid of edges or external reflections, any significant edge or external reflection makes the surrounding region a candidate for further device locating. This filter may be a Region Proposal Network (RPN), such as R-CNN (Region Proposal CNN) or Faster R-CNN (see arxiv.org/abs/1506.01497). An R-CNN uses simpler and fewer filters with larger stride to detect objects, without attempting to classify objects with high recall or precision. This approach might propose Region 1, 2 and 4 in FIG. 8 (where Region 1 contains perforations and threads that create glints).

A second alternative is to segment and select all regions systematically for the whole section of the well of interest. For example, a section of production tubulars from depth 2000 m to 2100 m might be segmented into 1 m lengths axially. This approach might select all Regions 1-4 in FIG. 8.

The image size of the region selected for processing preferably relates (in terms of pixels) to the size of the GPU that can be stored for efficient matrix operations and relates (in terms of physical units) to the size of the device. These are both related by the ultrasound scan resolution (pixels/mm or pixels/radian). In preferred embodiments, a region may be from 50 cm to 2 m axially, or may be 200-1000 pixels in either azimuthal or axial dimensions (not necessarily a square).

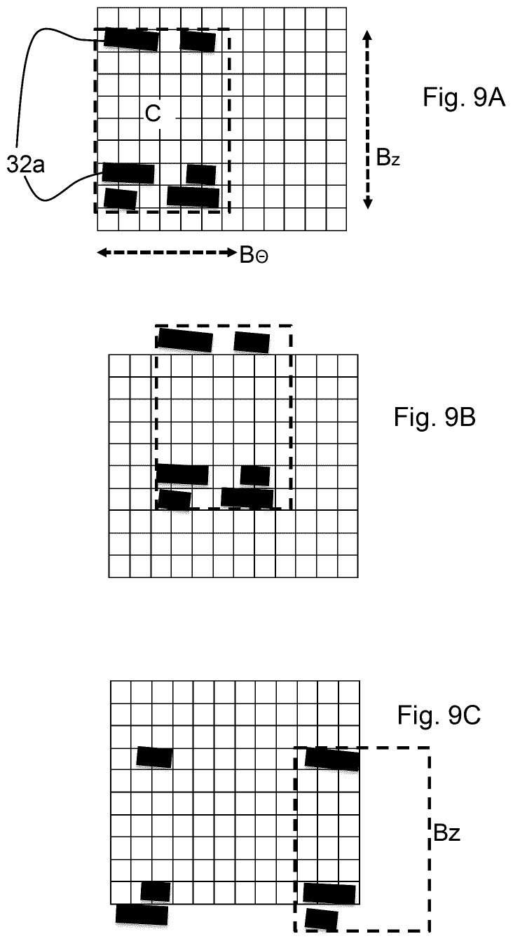

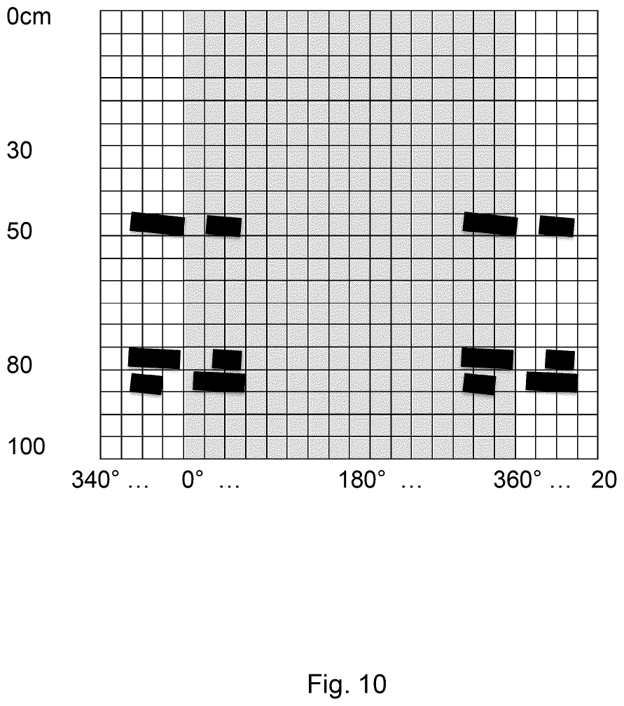

For gross simplification, FIGS. 9A-C illustrate a region of 10×12 pixels or 1 m×360°, so a pixel is 10 cm×30°, which is 10 times courser than in preferred embodiments. The black rectangles 32a are a simplification of the clamp captured in the real image of FIG. 5 using some input representation for intensity and pixel geometry. The model output is preferably some probability or classification of any device within the input image.

For example, the output location may be a bounding box defined by a center (Cz, CΘ), box height (Bz in mm) and box width (BΘ in radians or degrees). These will be in local coordinates of the selected region, which are then converted to global coordinates. Detected devices and their global locations are recorded in a database. The processor de-duplicates devices with overlapping locations. This may initially be done in the local image region using the Intersection over Union (IoU) method, on the premise that two devices cannot overlap, optionally de-duplicating with the stricter premise that two devices cannot be located in one image region. Similarly, de-duplication occurs at neighboring image regions, where overlap is determined based on global coordinates.

In FIG. 9A the device is perfectly enveloped by the selected image region, enabling the CNN to identify an object of class A confidently, and its dotted bounding box defined by local coordinates: Cz, CΘ, Bz, and BΘ. In FIG. 9B, the device is slightly outside of the region, so the CNN may identify an object with less confidence but still apply a bounding box, which extends past the region. This bounding box will be deduplicated with any box identified in the region above this, once global coordinates are considered. FIG. 9C represents a more difficult case, where the device is both partially outside of the region and wrapped around the edges in this 2D representation. This bounding box could equally be drawn at the left side due to the circular coordinates.

### Input Representation

In the preferred system, the input data is represented in three main axes: Θ, R and Z (the Z axis is also the logging axis separated in time by frames; R is the cross-sectional distance from the transducer array, measurable in time-sampled pixels or radial distance; and Θ corresponds to the azimuthal angle of a scan line). Here, the Θ-R plane represents data collected from a cross-sectional slice of the well at a specific depth (z) or logging time instant (t). One efficient representation is averaging the intensities over R for each scan line in the Θ-axis. Hence, the entire well or pipe can be represented by a 2-dimensional stream of 2D segments in the Θ-z plane, where every pixel along the Θ-axis at a given z, represents averaged line intensities. The size of the image to process may be based on the estimated device size.

Alternatively, the image may be represented by scan line features, such as intensity standard deviation or intensity center of mass. A preferred representation provides a good compromise between spatial and temporal features by averaging intensities along sub-regions along the R-axis on three separated planes. For example, the regions may be the pixels before the inner surface, pixels within the tubular itself, and pixels beyond the outer surface. Hence, instead of converting the well image from R-Θ-z to 1-Θ-z, the system converts them to 3-Θ-z, i.e. three intensity values per scanline for each pixel in azimuth and longitude.

Alternatively. the input data may be limited to signals beyond the tubular's outer surface, where the device is expected to reside. This external data may be selected or ‘clipped’ from the full data set in an automated process illustrated by FIGS. 13-17. The selected data may then be further reduced by computing the average or maximum intensity value per scanline within this clipped radial range Thus the input image is 1-Θ-z, i.e. a single intensity value per scanline for each pixel in azimuth and longitude.

In the exemplary systems below, the R-Θ-z to 1-Θ-z representation is used, using a single value to represent average intensity value per scan line.

### Template-Matching

In this embodiment, the system formalizes the device's orientation/detection as a classification problem. A goal is to detect whether each segment of tubular image contains a given device type, and if so, classify the mounting orientation of the device around the tubular. Different classes correspond to different shifts of the device template along the ( ) axis. Since devices can come in different shapes, the operator preferably indicates or loads a template of the current devices expected in the tubular under investigation. The first step is to divide the tubular image into image segments, z-pixels high. Here the value for z should be enough to envelope a device or a major feature of the device. Signals of each image segment may be normalized, scaled, and converted to 1-Θ-z representation to generate an input image. Then the system detects whether the current image segment contains the given device. This can be done by applying cross-correlation between the input image and shifts of the device template. The shift may be on a pixel-by-pixel basis or shifting P pixels per calculation, searching and moving towards maximum cross-correlation.

In another embodiment, a processor performs template matching by comparing a set of identified edges to sets of model edges in a library of devices. Here each device is associated with a set of model edges defined by shape, orientation, brightness or aspect ratio and their weighting. These model sets may be created from geometric measurements and CAD models considering the size of edges that contact the tubular and angle of these edges with respect to the scan line angle (i.e. brightness may change with incidence angle). These model sets may also be created by scanning multiple device specimens, extracting edges and averaging them over repeat scans of the same specimen.

For example, the processor may use template matching by sliding the identified set of edges over the set of model edges to find the best fit. Known techniques include cross-correlation and SAD (Sum of Absolute Differences). The technique may compute the dot-product of edges in the set of identified edges with the set of model edges of any device in the library. The technique then selects the relative spacing and orientation where this value is highest.

For example, if a higher than threshold cross-correlation is detected for any of several coarse shifts of the template along the Θ-axis, a device is detected but with poor orientation confidence. To determine the orientation of the detected device, the system constructs the cross-correlation value as a 1D vector, where each entry corresponds to the value of the cross-correlation for a fine template shift. Thus, the system can find the peak of the values of this vector and determine the device's orientation for the image segment.

### Device Identification Machine Learning (DML) Model

The device identification may use a two-stage approach: device orientation prediction using a CNN Devices detector module followed by a ResNet-based feature extractor and regression network.

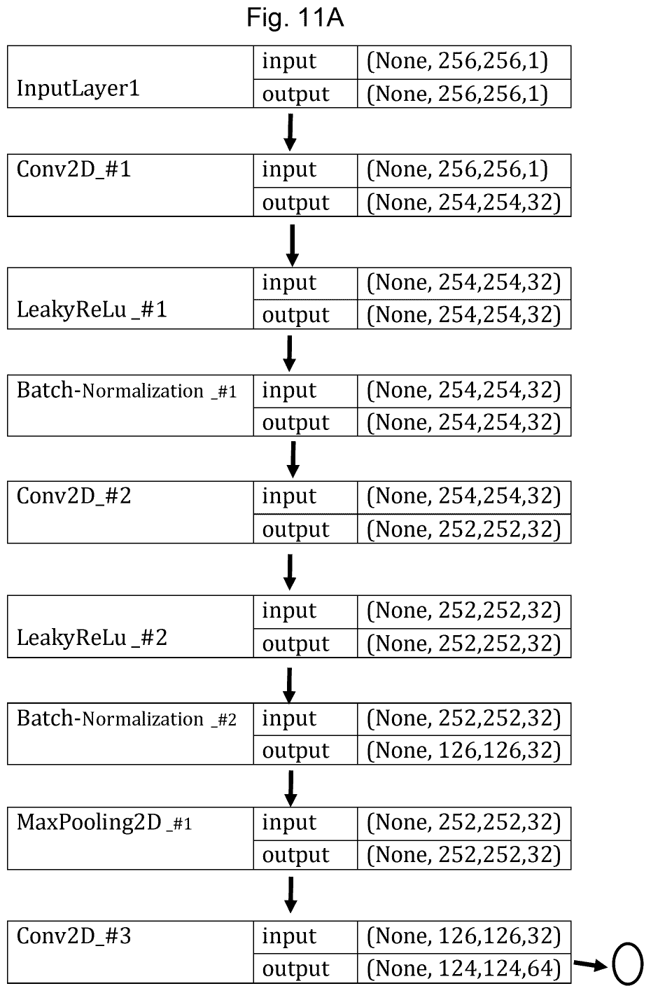

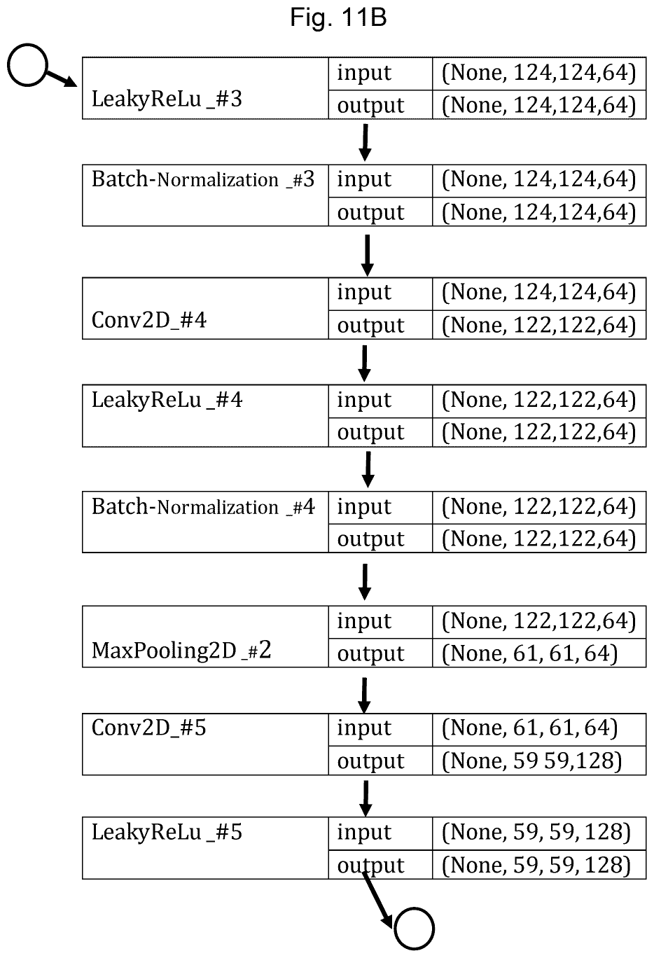

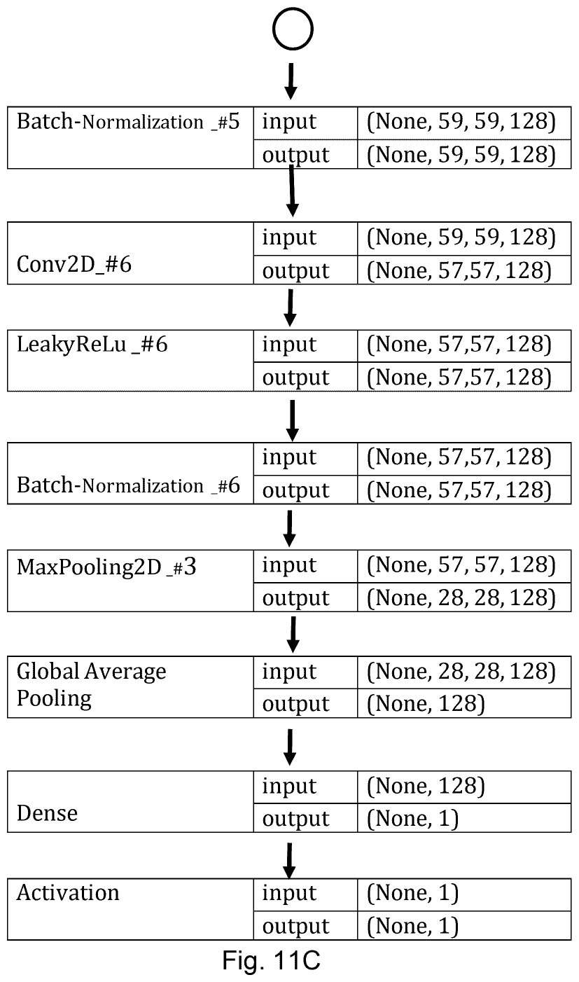

The DML model presented in this embodiment divides the problem into two main tasks. The first is device detection and the second is classifying the orientation of the detected device. FIG. 11 depicts an exemplary CNN architecture for device detection. The neural network learns a decision boundary separating device images from non-device images. The input to the device detector is a gray-scale image (e.g. 256z×256Θ×1), whereby each intensity value includes contributions from surfaces and device. The network comprises four convolutional layers that capture feature maps with increasing levels of abstraction. For activation functions, the architecture uses ReLU, preferably Leaky Rectified Linear Units (ReLU), to overcome the problem of vanishing gradients which is associated with Sigmoid activation functions. Moreover, Leaky ReLU is preferred over basic ReLU because it prevents the model from getting stuck in the negative region of the ReLU function during the training process. In addition, using Randomized ReLU activation increases the number of trainable parameters, which is not preferred especially if the training dataset is small. The architecture further employs a Batch Normalization layer, which normalizes and scales the input feature maps to each convolutional layer. Batch Normalization layers help in speeding up the training process and reduce the possibility of the model overfitting the training data. Because Batch Normalization helps reduce overfitting, the model does not need Dropout layers.

The architecture also uses Maximum Pooling layers to reduce the dimensions of output feature maps after each convolutional layer. Most conventional CNNs use stacked convolutional layers with increasing depth to extract relevant features and this is followed by two or three Fully Connected layers. In preferred embodiments, the system does not use Fully Connected layers except for the output decision node to avoid overfitting the training data.

Global Average Pooling (GAP) can be used with 3D tensors with varying width and height to 2D tensors, thus effectively reducing (Height×Width×Number_of_feature_maps) to (1×1×Number_of_feature_maps). The architecture may use a GAP layer instead of Fully Connected layers to help the model generalize better for unseen examples. Also using GAP forces the feature maps to be interpretable as they are one step away from the output decision node. Finally, a decision node is used with a Sigmoid activation function. The architecture may employ an Adam optimizer for training the devices detector, as it is easier to tune than a stochastic gradient descent optimizer. A stochastic gradient descent with momentum is also an alternative. A learning rate schedular is used to reduce the learning as a function of the current training epoch. The loss function for the optimizer in the case of device detection is the binary cross entropy function. Moreover, the evaluation metric is the weighted accuracy based on the distribution of device and non-device examples in the training dataset.

Certain embodiments of the model may use skipping connections (also called residual units) resulting in two important enhancements. First, by providing alternative shortcuts for gradients to flow during backpropagation, the problem of vanishing gradients is almost eliminated. Second, by incorporating skipping connections, the model is forced to learn an identity function ensuring higher layers perform at least as good as lower layers, hence higher layers never degrade the performance of the model.

Once the system has detected a device in the image segment, the system determines the orientation of the device. The system may treat this problem as a regression problem, where the input of the network is an image segment containing a clamp and the output is an orientation value in the continuous range from 0 to S scan lines (e.g. S=the 256 scan lines in the input image). Later, this output can be scaled to the [0, 360° ] range. An alternative but less accurate embodiment formalizes the problem as a classification task, where the output layer corresponds to 256 classes (discrete).

The system initially builds a training dataset of devices with different orientation angles, intensities, geometry and sizes. The training set may be generated by data-augmentation of collected, labelled ultrasound images (‘device’, ‘no device’) by shifting while wrapping around the collected data in Θ and estimating the new label based on the initial label and the amount of rotation in Θ (azimuthal variation). The training set may also comprise augmented images flipped around an axis, changing the brightness and the contrast of the image, without affecting the estimated label.

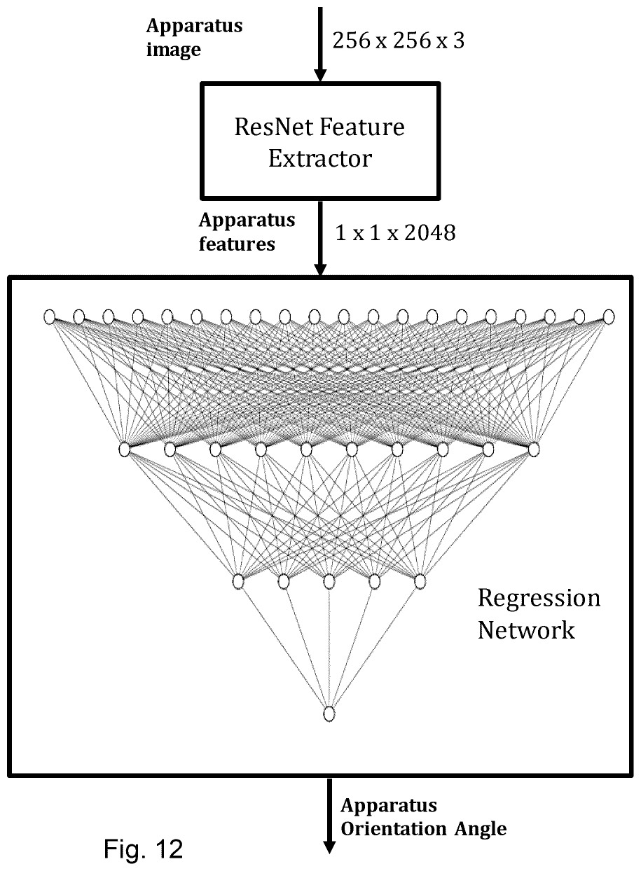

Additionally, the system may use a ResNet architecture to extract important features. This approach takes advantage of Transfer Learning by loading the ImageNef weights to extract important features from a small dataset of devices, then removing the top layers since they are more related to specific classes of objects from the Image Net dataset and were trained on a classification task rather than a regression task. ResNet architecture expects a three-input channel image, hence, the processor may stack the (256×256×1) grayscale image to construct a (256×256×3) image. The ResNet network maps the (256×256×3) input to (1×1×2048) features. The output features are then passed to a regression network consisting of multiple hidden units. The choice of the number of hidden layers and the depth of each layer can be decided using a grid search approach. FIG. 12 depicts one possible regression network for devices orientation prediction.

After initializing the weights of the ResNet feature extractor with ImageNet weights, there are two preferred options to train this network. The first is to freeze the weights of the ResNet feature extractor, hence, backpropagation will not update these layers and will only update the weights of the top fully connected layers. This approach is most suitable in cases where there is a very small dataset. The second approach is to train the entire network including the ResNet feature extractor but with varying learning rates depending on how deep the layers are relative to the input layer. Specifically, weights associated with layers closer to the output node are updated with a higher learning rate compared to layers further away and closer to the input node. The low-level features, like edges, are relevant to all objects and therefore the system should not update those kernels as much as it updates high level features that are unique to specific tubular objects imaged using ultrasound. Since this is a regression task, the system may optimize the loss function based on mean-squared error.

Instead of treating the problem of device orientation as a two-step process, first detecting the presence of a device (e.g. fiber clamp) and then determining its orientation, the system may comprise a single end-to-end regression network. In this case, the input to the learner is a segment (i.e., could either contain a clamp or not) and the output is a real-valued integer. During the labelling phase, every clamp segment would be assigned an orientation angle in the range [1, 360], while segments that do not contain clamps would be assigned a large negative value so that the mean-squared error loss function is heavily penalized when a clamp is misclassified as a non-clamp or vice versa.

### Orientation and Location

The tool comprises instrumentation to determine the orientation and location of the tool in the well. The instrumentation may include a 3-axis compass, 3-axis accelerometer, and measurement of deployed wireline. Thus, the determined orientation of the external devices relative to the transducers can be transformed to coordinates relevant to the well and its operators. These coordinates may then be used to visualize the devices for a known depth in the well or used with tools subsequently deployed to operate on the well.

### Perforation Gun Operation

In one application, an imaging tool may be used in conjunction with or connected to a downhole perforation gun. A perforation gun operates by moving on a drill string to various axial locations in the production portion of a wellbore and fires numerous charges to make holes through the casing, in order to allow fluids to pass therethrough. The orientations of the perforations may be controlled by the perf gun, particularly to avoid fiber optic cables and control cables. By identifying the location of cable protectors and their orientation, the location of the cable can be estimated to run therebetween. The identified device's location is input to the controller of the perforation gun to set a firing orientation and depth in order to miss the determined devices or its associated cables.

### Surface Detection by Machine Learning

In alternative embodiment, the inner surface of the tubular is automatically detected. The system may employ the techniques taught in US patent application US2022/0215526A1 titled “Machine Learning Model for Identifying Surfaces in a Tubular” filed 2 Dec. 2021, incorporated herein by reference.

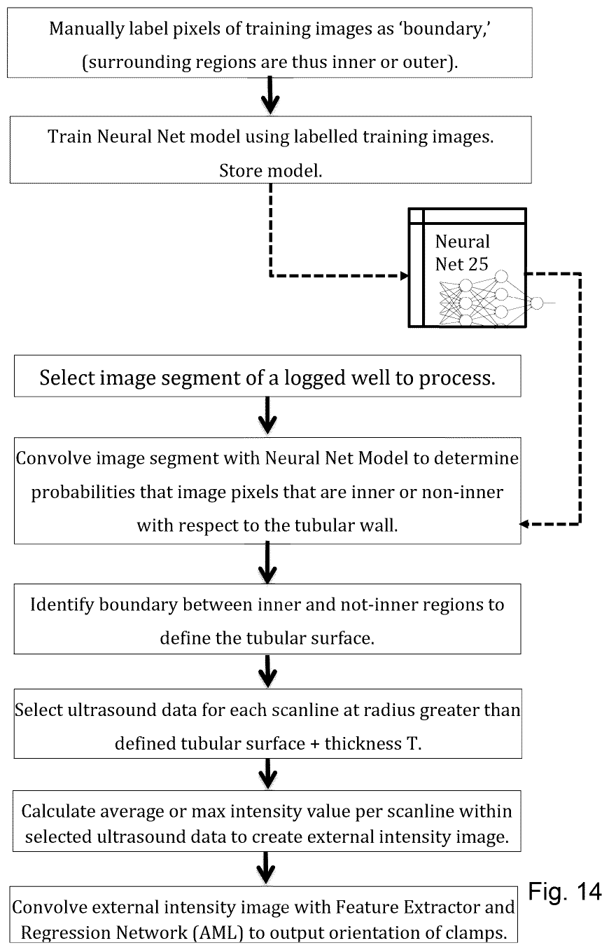

Disclosed therein and partially repeated below are a method and system to automatedly identify image internal and external areas of an image of a logged well from ultrasound images using a computer model. The model may be termed a Surface Machine Learning model (SML). FIG. 14 provides a flow chart to both train the SML 25 and then use it to determine probabilities of areas being inner or outer, with respect to a tubular. These outer areas relate to potential device reflections, which reflection signals are then processed to create an external intensity image, which is then used in the above Device Identification model (DML) to detect devices (if present). Thus, the end-to-end process may be automated to take raw ultrasound data and output a location and orientation of any extremely mounted devices.

For a selected image segment, the SML model returns probabilities Pᵢₙₜₑᵣₙₐₗ that an image area is internal to the tubular. As used herein, ‘areas’ may be a single pixel or contiguous areas/volumes of pixels sharing a common probability of being internal. The area does not necessarily correspond to pixels in the image space, but that is a convenient correspondence for computation. For example, the model's output may be that the physical area greater than 10 cm from the sensor is ‘external’, which actually corresponds to thousands of pixels in image space.

Without loss of generality the ultrasound image may be 3-dimensional, in which case the exemplary neural nets provided herein below have an extra dimension to convolve. However, to reduce processing time, the ultrasound image may be a 2D image with depth (z) and azimuthal (Θ) coordinates, as discussed above.

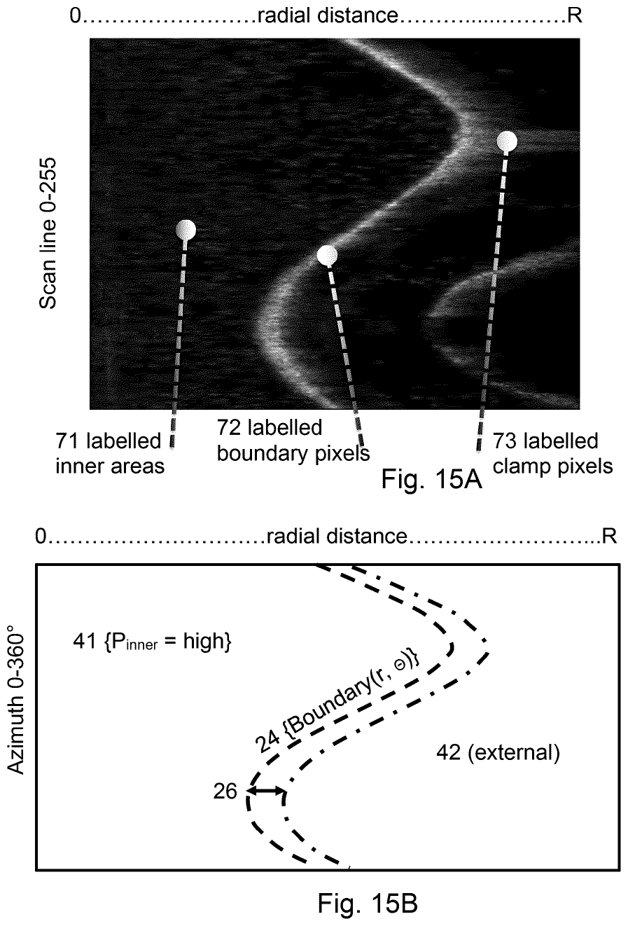

As shown in the probability map 41 of FIG. 15B, an ultrasound image convolved with a Neural Net 25 outputs probabilities that areas within the ultrasound image correspond to internal areas in the tubular. The probability that an area is ‘external’ 42 is simply the complement of it being ‘internal’. Further processing may involve finding the tubular surface by locating the transition between internal and external areas, (i.e. boundary 24), which identifies the surface of the tubular. This boundary output may be stored as pixel locations (z, r and Θ), where the determined surface is. FIG. 15B further indicates some wall thickness 26 of the tubular.

The SML model presented in this embodiment may use a U-Net architecture, as shown in FIG. 13. The output of this model partitions the image into internal and external areas. While the input to this model is a gray-scale image (e.g. 256z×256Θ×1), without loss of generality a sequence of images could be fed to similar architectures. The network uses an encoder and decoder modules for assigning pixels to internal and external areas.

The purpose of the encoder module is to provide a compact representation of its input. This module may comprise five convolution layers, but fewer or more layers could be used, trading off accuracy and processing time. Alternatively, spatial attention layers could be used instead of convolution layers. For a sequence of images, Recurrent Neural Networks (RNN), Long Short-Term Memory (LSTM) or spatio-temporal attention models could be used.

For activation functions, the encoder architecture uses Rectified Linear Units (ReLU), but other activation function such as Leaky or Randomized ReLUs could also be used to improve the accuracy of the model. The architecture further employs a Batch Normalization layer, which normalizes and scales the input feature maps to each convolutional layer. Batch Normalization layers help in speeding up the training process and reduce the possibility of the model overfitting the training data. Because Batch Normalization helps reduce overfitting, the model does not need Dropout layers.

The decoder module creates the probability map of a pixel belonging to external or an internal area. The input of the decoder module is the compact representation given by the encoder. This module comprises of five convolution layers with RELU activations, but fewer or more layers could be used as well. Similar to the encoder module, RNNs, LSTMs or spatio-temporal attention layers could be used for sequential input. In order to expand the compact representation, up-sampling functions are used in-between convolution layers.

The architecture may employ an Adam optimizer for training the ML model, as it is easier to tune than a stochastic gradient descent optimizer. A stochastic gradient descent with momentum is also an alternative. A learning rate scheduler may be used to reduce the learning as a function of the current training epoch. The loss function for the optimizer is the binary cross entropy function. FIG. 15A illustrates a training image where image areas or pixels have been labelled as inner 71, boundary 72, or clamp 73.

In the U-Net model, these standard-units are followed by pooling layers to decrease the dimensionality of their outputs in a downward path. The successive operation of standard-units and pooling layers gradually decreases the dimensionality of features into a bottleneck, which is a compact representation of the entire image. After the bottleneck, the standard-units are followed by unpooling layers to increase the dimensionality of feature maps to the original image size in an upward path.

Skip connections between downward and upward paths are used to concatenate feature maps. These skip connections create a gradient highway, which decreases training time and improves accuracy.

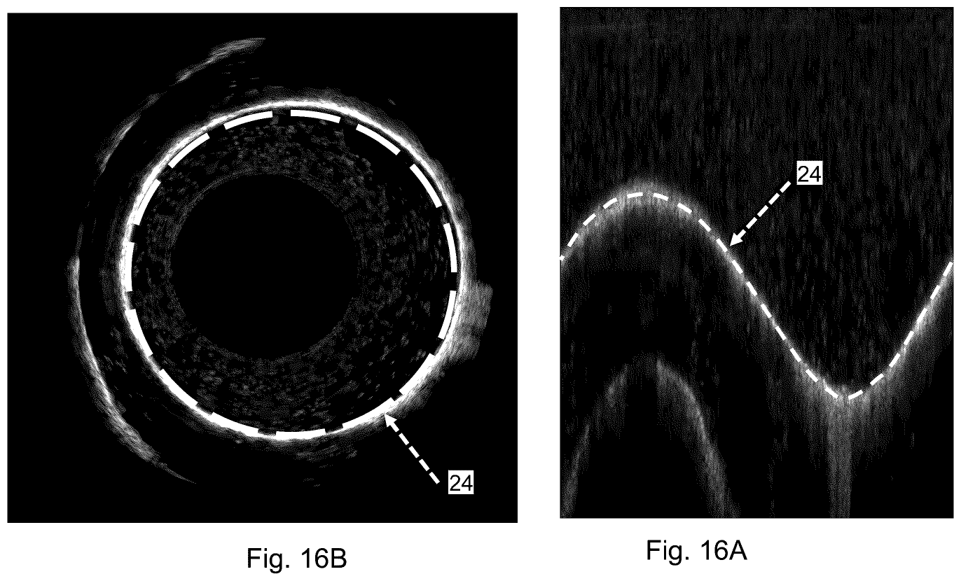

FIG. 16A (unwrapped scan lines) and 16B (wrapped scan lines) shows the output of the SML, whereby ultrasound images are shown overlaid with the boundary 24 between these internal and external areas. That is, for a given scan line some contiguous internal radius will be above the probability threshold of being internal, followed by a contiguous external radius below that threshold. Only the signals at distances from the acoustic sensor that are greater than the tubular surface (inner or outer surface) need to be considered in the detection of externally mounted devices using the Devices Identification Machine Learning model discussed above. For a radial acoustic transducer arrays concentric within the circular tubular, the distances will be radial distances from the center of the tool.

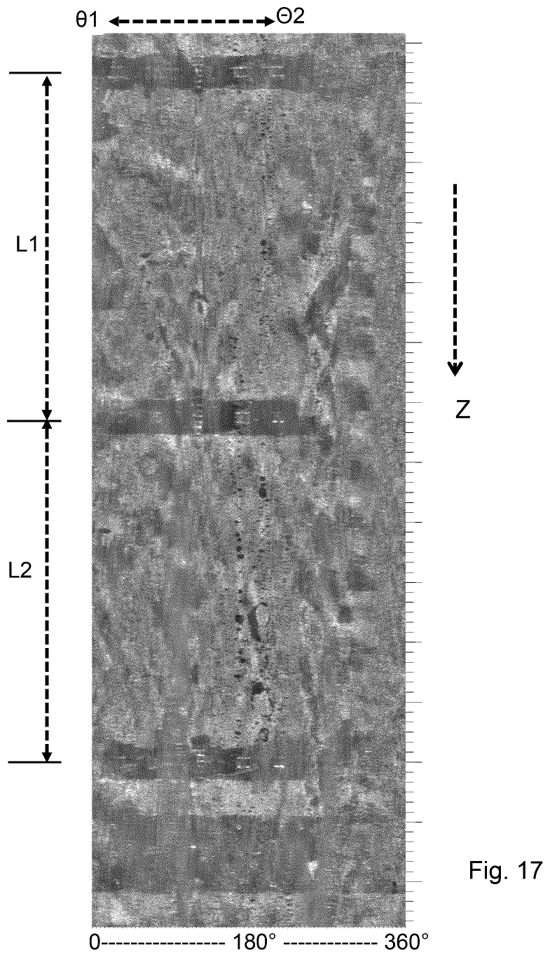

FIG. 17 is a sample ultrasound image after filtering out reflection signals from the inner areas and tubular itself, whereby pixels are the maximum intensity values for each scan line within the remaining external areas. As shown, bands of areas present themselves where the device is mounted with glints for certain features. The separation L1, L2 between these bands and azimuthal separation θ1, θ2 of features (in this example, teeth 22 of a clamp) are indicative of a device located at this depth Z in the well.

1. A method of locating devices mounted external to a tubular, the method comprising:
deploying an imaging tool having an acoustic transducer into the tubular;
creating acoustic images using the acoustic sensor from acoustic reflections from the tubular and portions of the device contacting the tubular;
processing the acoustic images with a first computer model to locate an inner surface of the tubular;
selecting data of the acoustic images that are beyond the located inner surface;
processing the selected data with a second computer model to determine locations of the devices; and
outputting the location of the devices.

2. The method of claim 1, wherein the selected data correspond to areas located from the acoustic sensor at distances greater than the located inner surface of the tubular.

3. The method of claim 1, wherein the selected data correspond to areas or volumes located from the acoustic sensor at distances greater than the located inner surface of the tubular plus a wall thickness of the tubular.

4. The method of claim 1, wherein the first computer model is a first machine learning model.

5. The method of claim 1, wherein the first computer model partitions the acoustic images into internal and external areas with respect to the tubular, then locates the inner surface at pixels in the acoustic images between the internal and external areas.

6. The method of claim 1, wherein the first computer model comprises one of: a U-Net architecture, Recurrent Neural Networks (RNN), Long Short-Term Memory (LSTM) and spatio-temporal attention model.

7. The method of claim 1, wherein the second computer model is a second machine learning model.

8. The method of claim 1, wherein the second computer model is a neural network, preferable comprising a ResNet architecture.

9. The method of claim 1, wherein the second computer model comprises a regression network to determine and output an azimuthal location of the devices with respect to the tubular.

10. The method of claim 1, wherein the acoustic images extend longitudinally along the tubular, circumferentially around the tubular, and radially into the tubular.

11. The method of claim 1, wherein the acoustic transducer is a radial ultrasonic phased array, and the acoustic images comprises signals for plural scan lines over time, radially outwards from the ultrasonic phased array.

12. The method of claim 1, further comprising calculating an intensity value along scan lines within the selected data, which intensity value represent at least one of: maximum intensity, average intensity, standard deviation of intensity, and radius of center of intensity.

13. A computer system comprising:
one or more non-transitory memories storing a first and second computer model for processing acoustic images; and
a processor configured to execute instructions stored in the one or more non-transitory memories to:
a) receive acoustic images of a tubular and devices mounted externally thereto;
b) process the acoustic images with the first computer model to locate an inner surface of the tubular;
c) select data of the acoustic images that are beyond the located inner surface;
d) process the selected data with the second computer model to determine locations of the devices; and
e) store the location of the devices in the one or more non-transitory memories.

14. The computer system of claim 13, wherein the selected data correspond to areas located from the acoustic sensor at distances greater than the located inner surface of the tubular.

15. The computer system of claim 13, wherein the first computer model is a machine learning model that partitions the acoustic images into internal and external areas with respect to the tubular, then locates the inner surface at pixels in the acoustic images between the internal and external areas.

16. The computer system of claim 13, wherein the first computer model comprises one of: a U-Net architecture, Recurrent Neural Networks (RNN), Long Short-Term Memory (LSTM) and spatio-temporal attention model.

17. The computer system of claim 13, wherein the second computer model is a neural network, preferable comprising a ResNet architecture.

18. The computer system of claim 13, wherein the second computer model comprises a regression network to determine and output an azimuthal location of the devices with respect to the tubular.

19. The computer system of claim 13, the processor further calculating an intensity value along scan lines within the selected data, which intensity value represent at least one of: maximum intensity, average intensity, standard deviation of intensity, and radius of center of intensity.
